(19) United States
(12) Patent Application Publication
(10) Pub. No.: US 2003/0142147 A1
(43) Pub. Date: Jul. 31, 2003

(54) Display method for query by tree search

(75) Inventors: Ming-Chih Chen, Taipei (TW); Ming-Wei Chuang, Taipei (TW)

Correspondence Address: BRUCE H. TROXELL, SUITE 1404, 5205 LEESBURG PIKE, FALLS CHURCH, VA, 22041, US

(73) Assignee: Kinpo Electronics, Inc.

(21) Appl. No.: 10/059,035

(22) Filed: Jan. 30, 2002

(51) Int. Cl. G09G 5/00

(52) U.S. Cl. 345/854

(57) ABSTRACT

This invention relates to a display method for query by tree search which method is to have several rows of symbols (such as alphabet or character) used for query appeared on display screen first; then to click one of said rows of symbols and the clicked rows of symbols are longitudinally arrayed as column and appeared on said display screen; after further to click the symbol going to be clicked, all words saved with the same initial as said symbol clicked are appeared on said display screen; and subsequently to click the queried word to show all information related to the queried word on said display screen.

### BACKGROUND OF THE INVENTION

1. Field of the Invention

The present invention relates to a display method for query by way of tree search, and more particularly to a searchable display method applicable to PDA (personal digital assistants), translating machine or portable telephone to easily search text file saved therein.

2. Description of Related Art

In general, translating machine, PDA (personal digital assistants) or portable telephone could have saved a mass of text file for query application to user.

The general display method for text search model comprises fuzzy search display (immediately search display), exact search display (directly search display) and general search display. For sake of conveniently illustration, taking how to search certain name lodged in telephone directory of PDA or portable telephone as an example for search display method to comparably illustrate what is good and bad to each search display method mentioned above.

Referring to FIG. 1A, FIG. 1B, FIG. 1C and FIG. 1D, the searching steps for fuzzy search display (immediately search display) is displayed a name input column 11 for query on display screen 10, if the first character of a name is keyed in by user, all names saved with the same as first character will be immediately appeared on displaying column 12 located under said name input column 11 (as shown in FIG. 1B), and if subsequently the second character of said name is keyed in, all names saved the same as both first and second characters will be appeared on said displaying column 12 (as shown in FIG. 1C), at this moment, user can operate the upper key or down key to selectively pick out the name for query and key the enter key for confirmation so that the searched name appears on said name input column 11 and all personal details related to that name will completely show on said displaying column 12 (as shown in FIG. 1D). This text search model is capably provided user takes less time to efficiently query the needed information and user may also make a fuzzy search to query related information by search and by query simultaneously, but this model must be occupied very much memory capacity of ROM and RAM, and the device used need be provided with much more input keys to input alphabet of A^{˜}Z.

Referring to FIG. 2A, FIG. 2B, FIG. 2C, FIG. 2D, FIG. 2E, and FIG. 2F, for exact search display (directly search display) user must key in all characters of full name for query on a name input column 11 of display screen 10 (as shown in FIG. 2A, FIG. 2B, FIG. 2C, FIG. 2D, and FIG. 2E), and all personal details related to said searched name will completely show on said displaying column 12 (as shown in FIG. 2F) after enter key is keyed in for confirmation. This text search model may be occupied much less memory capacity of ROM and RAM than that of fuzzy search method, but this model can not make a fuzzy search to query related information by search and by query simultaneously, and it is hardly searchable to query any related information if user do not knows or once forgets any character of certain person's name for query, and the device used need be provided with much more input keys to input alphabet of A^{˜}Z also.

Referring to FIG. 3A, FIG. 3B, FIG. 3C, FIG. 3D, FIG. 3E, and FIG. 3F, for general search display, a displaying column 21 used to display searchable names is displayed on display screen 20, and all names saved will be entirely appeared on said displaying column 21 if the user starts entering the picture searchable for name query. The user for query must move the cursor control keys upper or down until what a name going to be searched is exactly queried (as shown in FIG. 3B, FIG. 3C, FIG. 3D, and FIG. 3E), and then to press down the enter key for confirmation all personal details related user's queried name will be appeared on said displaying column 21 (as shown in FIG. 3F). This text search model may be occupied much less memory capacity of ROM and RAM, sand hardware device for use only provided with the cursor control keys is enough to make a searchable name query so that much more input keys for inputting any alphabet of A^{˜}Z are unnecessary and saved, but this model still consumes much times for query if the query file of information saved are too much and this model can not make a fuzzy search by search and by query simultaneously too.

### SUMMARY OF THE INVENTION

This present invention is disclosed a display method for query by tree search technique provided with all good traits but without drawbacks of those general display methods for text search model mentioned above.

The primary objective of this present invention is to provide a display method for query by tree search to more and more save both memory capacity occupied on ROM and RAM and reduce some input keys unnecessary, in addition, capably to make a fuzzy search by search and by query simultaneously to save much times for query.

### BRIEF DESCRIPTION OF THE DRAWINGS

The invention is description in detail with reference to the following drawings, wherein like numerals represent like elements:

FIG. 1A, FIG. 1B, FIG. 1C and FIG. 1D, are illustrate drawings related to a fuzzy search display (immediately search display) when executed.

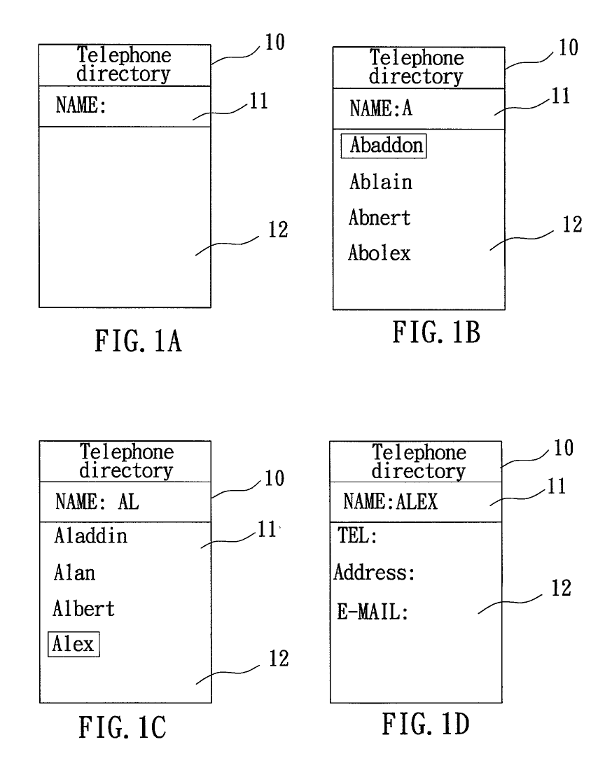

FIG. 2A, FIG. 2B, FIG. 2C, FIG. 2D, FIG. 2E, and FIG. 2F, are illustrate drawings related to an exact search display (directly search display) when executed.

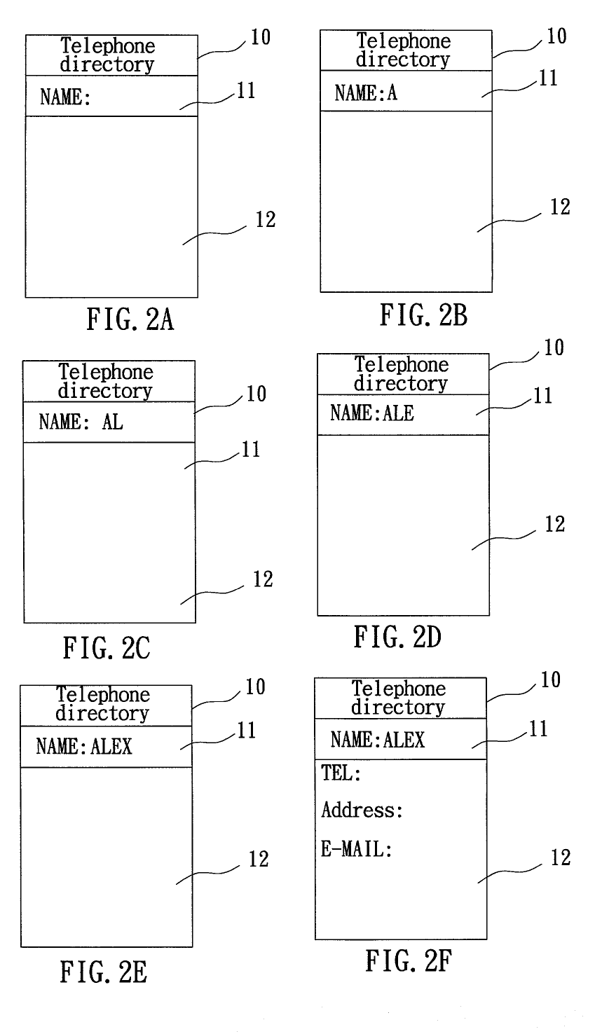

FIG. 3A, FIG. 3B, FIG. 3C, FIG. 3D, FIG. 3E, and FIG. 3F are illustrate drawings related to a general search display when executed.

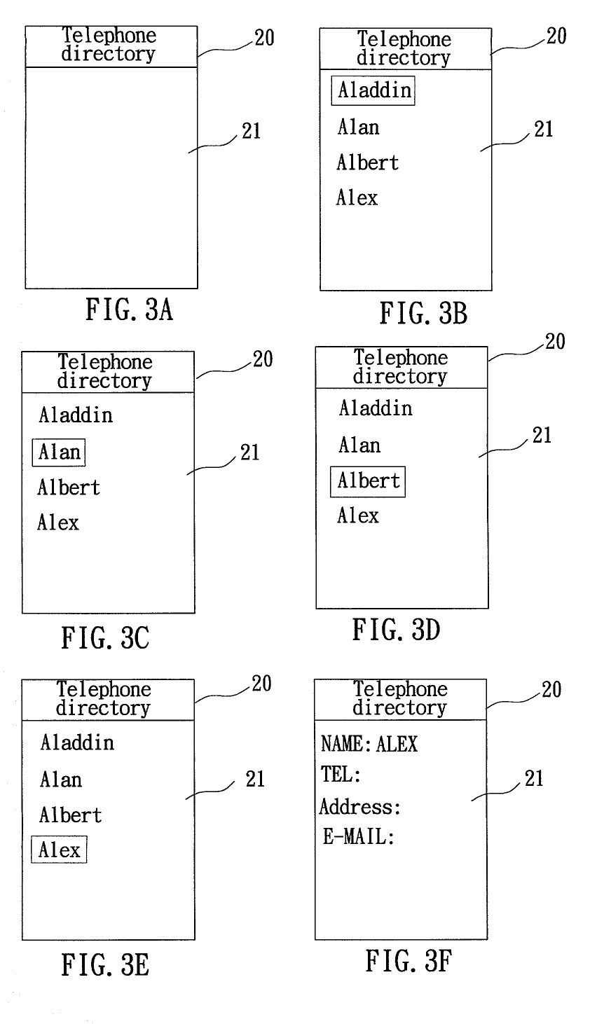

FIG. 4A, FIG. 4B, FIG. 4C, FIG. 4D, FIG. 4E, and FIG. 4F are illustrate drawings related to first embodiment of display method of this present invention when executed.

FIG. 5 is a block diagram of first embodiment of display method of this present invention.

FIG. 6A, FIG. 6B, FIG. 6C, FIG. 6D, FIG. 6E, and FIG. 6F are illustrate drawings related to second embodiment of display method of this present invention when executed.

FIG. 7 is a block diagram of second embodiment of display method of this present invention.

### DETAILED DESCRIPTION OF THE PREFERRED EMBODIMENT

For sake of conveniently illustration, still taking how to make use of this present invention to search certain name lodged in telephone directory of PDA or portable telephone as an example.

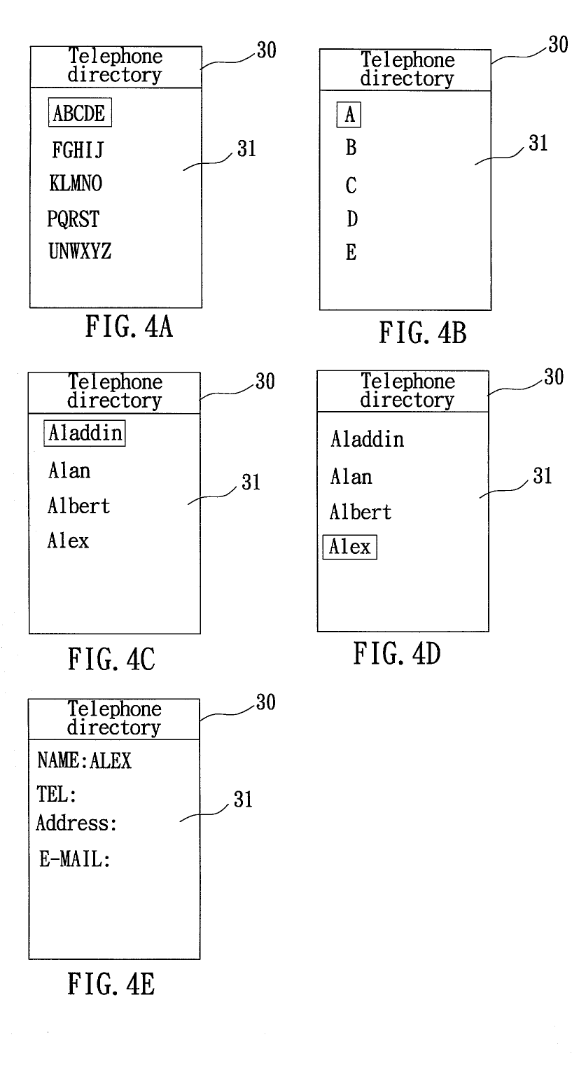

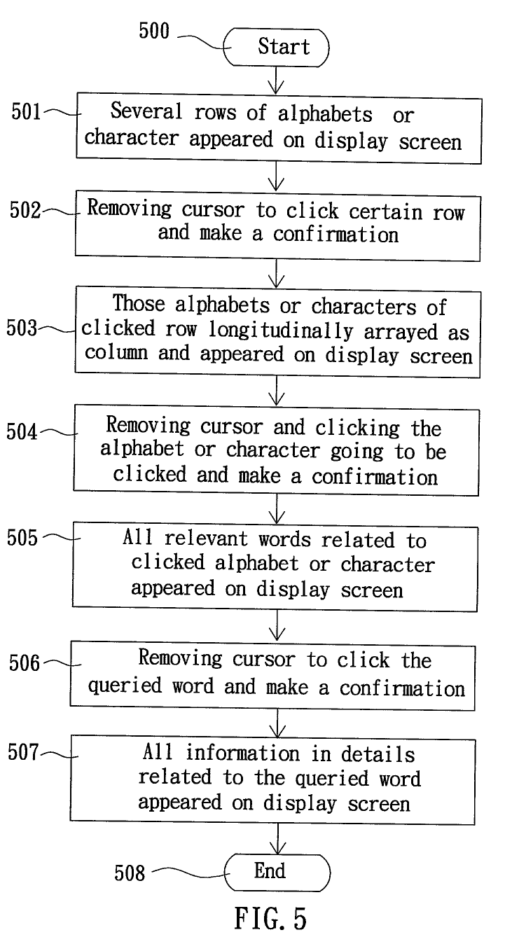

The first embodiment of display method for query by tree search of this invention is shown on FIG. 4 and FIG. 5, which executed steps comprises the following steps:

501 a displaying column 31 for query is displayed on display screen 30 to be appeared five rows of alphabetic combination in alphabetical order (as shown in FIG. 4A);

502 according to cursor's movement to click certain row and make a confirmation;

503 those alphabets combined as row clicked in above step are longitudinally arrayed as column and appeared on said displaying column 31 of display screen 30 (as shown in FIG. 4B);

504 removing cursor to the character going to be clicked and make a confirmation;

505 all names, saved with the same initial as said character clicked in above step, are appeared on said displaying column 31 of display screen 30 (as shown in FIG. 4C);

506 removing cursor to the queried name and click to make a confirmation (as shown in FIG. 4D);

507 all personal details related to the queried name are appeared on said displaying column 31 of display screen 30 (as shown in FIG. 4E).

According to the first embodiment of display method for query of this invention, some input keys used in hardware device are unnecessary and reduced. Because user, for query just to remove cursor (upper and down) control keys and click enter key for confirmation, not only can easily query the searchable name file saved on memory but also can make a fuzzy search by search and by query simultaneously to save much times for query and save more and more memory capacity occupied on ROM and RAM.

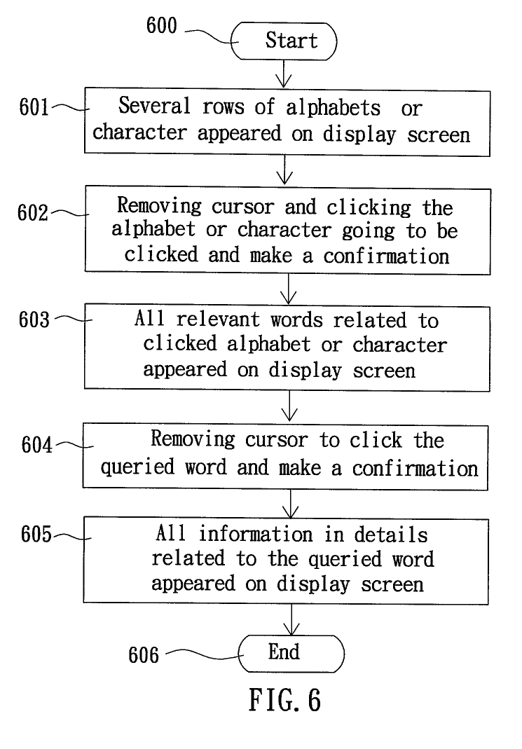

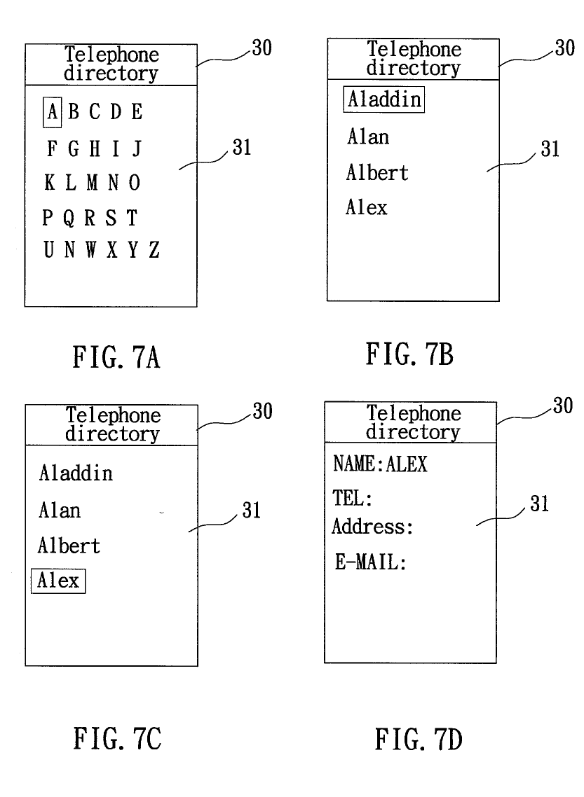

The second embodiment of display method for query by tree search of this invention is shown on FIG. 6 and FIG. 7, which executed steps comprises the following steps:

601 each alphabet arranged in alphabetical order and in interval are appeared on displaying column 31 of display screen 30;

602 removing cursor to the alphabet going to be clicked and make a confirmation (as shown in FIG. 7A); 603 all names, saved with the same initial as said alphabet clicked in above step, are appeared on said displaying column 31 of display screen 30 (as shown in FIG. 7B);

604 removing cursor to the queried name and click to make a confirmation (as shown in FIG. 7C);

605 all personal details related to the queried name are appeared on said displaying column 31 of display screen 30 (as shown in FIG. 7D).

According to the second embodiment of display method for query of this invention, some input keys used in hardware device are unnecessary and reduced. Because user, for query just to remove cursor (upper, down, left and right) control keys and click enter key for confirmation, not only can easily query the searchable name file saved on memory but also can make a fuzzy search by search and by query simultaneously to save much times for query and save more and more memory capacity occupied on ROM and RAM.

The display method for query by tree search of this invention shown above can be applicable to search any kind of text file saved of which alphabet or character is provided with. This display method of disclosed invention is still applicable to search text or word information by symbol for pronunciation to alphabet or character or by synthesized symbol specially used for text or word search.

The scope of this disclosed invention is not limited to the embodiment illustrated as above. Which scope explained and defined by claims may include all changeable equivalents more particularly only changed in easy amendment or variation.

What is claimed is:

1. A display method for query by tree search comprises steps of:
(a) to have several rows of symbols in combination used for query appeared on display screen;
(b) removing cursor to certain row of symbols in combination wherein included this symbol for query and click said row of symbols in combination for confirmation;
(C) symbols in combination of said clicked row in above step are longitudinally arrayed as column and appeared on said display screen;
(d) removing cursor to the symbol going to be clicked and make a confirmation;
(e) all words saved with the same initial as said symbol clicked in above step are appeared on said display screen;
(f) removing cursor to the queried word and click to make a confirmation; and
(g) all information related to the queried word are appeared on said display screen.

2. A display method for query by tree search as defined by claim 1, wherein the symbol used for query is an alphabet or a character.

3. A display method for query by tree search as defined by claim 1, wherein the symbol used for query is a symbol for pronunciation to alphabet or character.

4. A display method for query by tree search as defined by claim 1, wherein the symbol used for query is a synthesized symbol specially used for text or word search.

5. A display method for query by tree search comprises steps of:
(a) to have several rows of symbols used for query appeared on display screen in interval arrangement;
(b) removing cursor to the symbol going to be clicked and make a confirmation;
(C) all words saved with the same initial as said symbol clicked in above step are appeared on said display screen;
(d) removing cursor to the queried word and click to make a confirmation; and
(e) all information related to the queried word are appeared on said display screen.

6. A display method for query by tree search as defined by claim 5, wherein the symbol used for query is an alphabet or a character.

7. A display method for query by tree search as defined by claim 5, wherein the symbol used for query is a symbol for pronunciation to alphabet or character.

8. A display method for query by tree search as defined by claim 5, wherein the symbol used for query is a synthesized symbol specially used for text or word search.
